(19) United States
(12) Patent Application Publication
(10) Pub. No.: US 2010/0072967 A1
(43) Pub. Date: Mar. 25, 2010

(54) CONVERTER CONTROL CIRCUIT

(75) Inventors: Takashi Kamishinbara, Kanagawa-ken (JP); Noriaki Yoshikawa, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/464,172

(22) Filed: May 12, 2009

(30) Foreign Application Priority Data
Sep. 19, 2008 (JP) 2008-240790

(51) Int. Cl. G05F 1/10

(52) U.S. Cl. 323/284

(57) ABSTRACT

There is provided a converter control circuit including: a high-side switching element connected between an input voltage terminal and an inductive load; a low-side switching element connected between the inductive load and a reference potential; a drive circuit configured to drive a gate of the switching elements; a drive switch connected to the gate of at least one of the switching elements in parallel with the drive circuit; and a drive switch control circuit switching the drive switch from ON to OFF when the gate voltage of the switching element with the gate connected to the drive switch reaches a prescribed threshold while the switching element is driven by the drive circuit.

### CROSS-REFERENCE TO RELATED APPLICATIONS

This application is based upon and claims the benefits of priority from the prior Japanese Patent Application No. 2008-240790, filed on Sep. 19, 2008; the entire contents of which are incorporated herein by reference.

### BACKGROUND OF THE INVENTION

1. Field of the Invention

This invention relates to a converter control circuit.

2. Background Art

A DC-DC converter is known to convert an input voltage to an output voltage (e.g., JP-A-2002-281744 (Kokai)). The converter has a high-side switching element and a low-side switching element, connected in series between an input voltage terminal and a reference potential, alternately turned on/off. A MOSFET (metal-oxide-semiconductor field effect transistor) is typically used as a switching element in the DC-DC converter. But, the MOSFET has a problem. A switching loss increases to increase in a pulse rise time and fall time of its drain-source voltage. Therefore, power efficiency decreases.

If a current capacity of a MOSFET gate drive circuit is increased to perform fast injection and extraction of charge on a gate of the MOSFET, the pulse rise and fall time of the drain-source voltage is decreased, and the switching loss can be reduced. However, in this case, when gate signal switches, switching noise increases, and consequently, the output voltage excessively including noise may adversely affect other devices.

That is, when the MOSFET fast switches with pulse rise or fall time, noise of turn-on and off increases. Conversely, when the MOSFET slowly rises or falls at its switching to reduce noise of turn-on and off. As a results, the power efficiency decreases.

### SUMMARY OF THE INVENTION

According to an aspect of the invention, there is provided a converter control circuit including: a high-side switching element connected between an input voltage terminal and an inductive load; a low-side switching element connected between the inductive load and a reference potential; a drive circuit configured to drive a gate of the switching elements; a drive switch connected to the gate of at least one of the switching elements in parallel with the drive circuit; and a drive switch control circuit switching the drive switch from ON to OFF when the gate voltage of the switching element with the gate connected to the drive switch reaches a prescribed threshold while the switching element is driven by the drive circuit.

### BRIEF DESCRIPTION OF THE DRAWINGS

FIG. 1 is a circuit diagram of a DC-DC converter according to a first embodiment of the invention;

FIG. 2A shows a drive stage gate signal applied to each gate of pMOS1 and nMOS1 of a high-side drive circuit 15;

FIG. 2B shows a fast drive switch control signal applied from a fast drive switch control circuit 18 to a gate of a fast drive switch 16;

FIG. 2C shows a gate voltage GH of a high-side switching element 11;

FIG. 2D shows a potential (output voltage) LX of a line 28;

FIG. 3 is a circuit diagram of a first example of the fast drive switch control circuit 18;

FIG. 4A shows an output signal VDRV_N of an inverter 36 to be inputted to a NOR circuit 37;

FIG. 4B shows an input signal VDRV to the inverter 36;

FIG. 4C shows a drive stage gate signal applied to the gate of pMOS1 and nMOS1 of the high-side drive circuit 15 and inputted to the NOR circuit 37;

FIG. 4D shows an output signal of an inverter 38 (the fast drive switch control signal applied from the fast drive switch control circuit 18 to the gate of the fast drive switch 16);

FIG. 4E shows a gate voltage GH of the high-side switching element 11;

FIG. 5 is a circuit diagram of a second example of the fast drive switch control circuit 18;

FIG. 6A shows an output signal VDRV_N of an inverter 36 to be inputted to the NOR circuit 37;

FIG. 6B shows an output signal VL_A_N of an inverter 41;

FIG. 6C shows an output signal VH_A of a VH detecting section;

FIG. 6D shows a drive stage gate signal;

FIG. 6E shows an output signal of the inverter 38 (a fast drive switch control signal applied from the fast drive switch control circuit 18 to the gate of the fast drive switch 16);

FIG. 6F shows a gate voltage GH of the high-side switching element 11;

FIG. 7 is a circuit diagram of a third example of the fast drive switch control circuit 18;

FIG. 8A shows an output signal VDRV_N of the inverter 36 to be inputted to the NOR circuit 37;

FIG. 8B shows a reference voltage inputted to a non-inverting input terminal of a differential amplifier 51;

FIG. 8C shows a drive stage gate signal;

FIG. 8D shows an output signal of the inverter 38 (a fast drive switch control signal applied from the fast drive switch control circuit 18 to the gate of the fast drive switch 16);

FIG. 8E shows a gate voltage GH of the high-side switching element 11;

FIG. 9 is a circuit diagram of a DC-DC converter according to a second embodiment of the invention;

FIG. 10 is a circuit diagram of a DC-DC converter according to a third embodiment of the invention;

FIG. 11 is a graph illustrating relations of increasing and decreasing of an on-detection threshold of a gate voltage GH in accordance with increasing and decreasing of an output current IL;

FIG. 12 is a circuit diagram of a DC-DC converter according to a fourth embodiment of the invention;

FIG. 13 is a circuit diagram of a DC-DC converter according to a fifth embodiment of the invention; and

FIG. 14 is a circuit diagram of a DC-DC converter according to a sixth embodiment of the invention.

### DETAILED DESCRIPTION OF THE INVENTION

Embodiments of the invention will now be described with reference to the drawings.

### First Embodiment

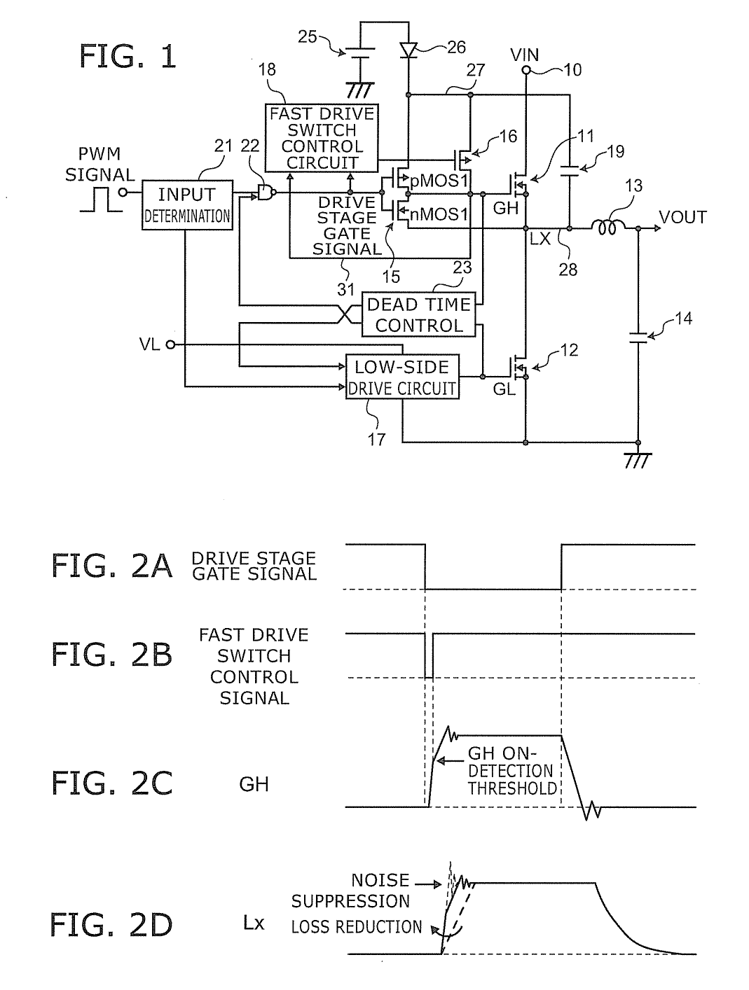

FIG. 1 is a circuit diagram of a DC-DC converter according to a first embodiment of the invention.

This DC-DC converter is a stepdown DC-DC converter comprising a high-side switching element 11 and a low-side switching element 12 connected in series between an input terminal 10 supplied with an input voltage VIN and a reference potential (ground). The high-side switching element 11 and a low-side switching element 12 are alternately turned on/off to generate an output voltage VOUT which is lower (on average) than the input voltage VIN. Each of the high-side switching element 11 and the low-side switching element 12 is an n-channel MOSFET (metal-oxide-semiconductor field effect transistor), for example.

A drain of the high-side switching element 11 is connected to the input terminal 10, and its source is connected to both of one end of an inductor 13 as an inductive load and a drain of the low-side switching element 12. The drain of the low-side switching element 12 is connected to both of the one end of the inductor 13 and the source of the high-side switching element 11. A source of the low-side switching element 12 is connected to the ground. A smoothing capacitor 14 connects between the other end of the inductor 13 and the ground for preventing its output voltage from greatly varying in a short period of time.

A gate of the high-side switching element 11 is connected to a high-side drive circuit 15. The high-side drive circuit 15 includes a p-channel MOSFET pMOS1, an n-channel MOSFET nMOS1, and a NAND circuit 22 connected to the gates thereof. The high-side drive circuit 15 drives the gate of the high-side switching element 11.

A source of pMOS1 is connected to a voltage source 25 through a diode 26. Each drain of pMOS1 and nMOS1 is connected to the gate of the high-side switching element 11. A source of nMOS1 is connected to a line 28 to which the source of the high-side switching element 11, the source of the low-side switching element 12, and the one end of the inductor 13 are respectively connected.

The voltage source 25 is connected to the line 28 between the inductor 13 and a junction of the high-side switching element 11 and the low-side switching element 12 through the diode 26, a power supply line 27, and a bootstrap capacitor 19.

A fast drive switch 16 is connected in parallel with the high-side drive circuit 15 between the voltage source 25 and the gate of the high-side switching element 11. The fast drive switch 16 is a p-channel MOSFET, with its source connected to the power supply line 27 and its drain connected to the gate of the high-side switching element 11. A gate of the fast drive switch 16 is supplied with a control signal from a fast drive switch control circuit 18, and the fast drive switch 16 is turned on/off by the control signal of the fast drive switch control circuit 18.

The gate of the low-side switching element 12 is connected to a low-side drive circuit 17 having elements similar to that of the high-side drive circuit 15. The low-side drive circuit 17 drives the gate of the low-side switching element 12. In the embodiment shown in FIG. 1, there are not circuits corresponding to the fast drive switch 16 and its control circuit 18 on the high side described above, on the low-side. The low-side drive circuit 17 only injects and extracts charge at the gate of the low-side switching element 12.

When a PWM (pulse width modulation) signal is inputted to an input determination circuit 21, the input determination circuit 21 generates a gate signal having nearly opposite phases and supplies it to the high-side drive circuit 15 and the low-side drive circuit 17.

If both the high-side switching element 11 and the low-side switching element 12 are simultaneously turned on, a through current flows from the input terminal 10 through the switching elements 11 and 12 to the ground. To avoid such operation, an on/off duty of the switching elements 11 and 12 is set with a dead time. Both the switching elements hand 12 are simultaneously turned off during the dead time. The dead time control circuit 23 monitors a variation of the gate voltage of the switching elements 11 and 12 to control the dead time.

When the high-side switching element 11 is turned on and the low-side switching element 12 is turned off, a current is supplied from the input terminal 10 through the high-side switching element 11, the line 28, and the inductor 13 to a load. At this time, the inductor current increases and accumulates energy in the inductor 13.

Then, when the high-side switching element 11 is turned off and the low-side switching element 12 is turned on, an electromotive force by the energy of the inductor 13 causes a current to flow from the ground through the low-side switching element 12, the line 28, and the inductor 13 to the load.

When pMOS1 is turned on and nMOS1 is turned off in the high-side drive circuit 15, positive charge is injected from the voltage source 25 through pMOS1 to the gate of the high-side switching element 11, and the high-side switching element 11 turns on. When pMOS1 is turned off and nMOS1 is turned on in the high-side drive circuit 15, positive charge is extracted from the gate of the high-side switching element 11 through nMOS1, and the high-side switching element 11 turns off.

In the case where the high-side switching element 11 is an n-channel MOSFET, the voltage level of the voltage source 25 with reference to the ground level may be insufficient to turn on the high-side switching element 11. Thus, in this embodiment, a bootstrap driving is applied. That is, when the low-side switching element 12 is turned on, the capacitor 19 is charged with the voltage Vdd of the voltage source 25 through the diode 26 (which may be replaced by a MOSFET). When the low-side switching element 12 is turned off and the high-side switching element 11 is turned on, the potential difference of the capacitor 19 is held at Vdd with reference to the potential of the line 28. Hence the potential of the power supply line 27 of the high-side drive circuit 15 is held at the potential of the line 28 plus Vdd, so that the high-side switching element 11 of the n-channel type can be completely turned on.

In this embodiment, the fast drive switch 16 is connected in parallel with the high-side drive circuit 15 between the voltage source 25 and the gate of the high-side switching element 11. An operation of the fast drive switch 16 is described below with reference to a waveform timing chart of FIG. 2.

FIG. 2A shows a drive stage gate signal applied to each gate of pMOS1 and nMOS1 of the high-side drive circuit 15, FIG. 2B shows a fast drive switch control signal applied from the fast drive switch control circuit 18 to the gate of the fast drive switch 16, FIG. 2C shows a gate voltage GH of the high-side switching element 11, and FIG. 2D shows a potential (output voltage) LX of the line 28.

When the drive stage gate signal switches from HIGH to LOW, the fast drive switch control signal also switches from HIGH to LOW at the same time. Thus, both pMOS1 and the fast drive switch 16 are turned on, and a positive charge is injected to the gate of the high-side switching element 11 from the power supply line 27 through pMOS1 and the fast drive switch 16. Therefore, the gate voltage (gate-source voltage) GH of the high-side switching element 11 quickly rise. Thus, as both pMOS1 and the fast drive switch 16 can be turned on, a rise time of the gate voltage GH of the high-side switching element 11 reduces.

After both pMOS1 and the fast drive switch 16 turning on, when the gate voltage GH exceeds a GH on-detection threshold (first threshold) of the fast drive switch control circuit 18, the fast drive switch control signal switches from LOW to HIGH to turn off the fast drive switch 16, and charge is injected only through pMOS1. This operation serves to be reduce a switching noise in the output voltage LX. The GH on-detection threshold is a gate voltage GH at which the potential (output voltage) LX of the line 28 is equal to the input voltage VIN, after the high-side switching element 11 turning on.

According to this embodiment, both pMOS1 and the fast drive switch 16 are turned on to increase the current capacity of the gate drive circuit and to achieve steep rise at the rise time of the gate voltage GH of the high-side switching element 11. After completion of the rise of the output voltage LX, the fast drive switch 16 is turned off to decrease the current capacity of the gate drive circuit to suppress noise. Such a simple circuit of this embodiment can reduce switching loss to improve efficiency, and suppress noise in the output voltage.

Specific examples of the fast drive switch control circuit 18 include the following.

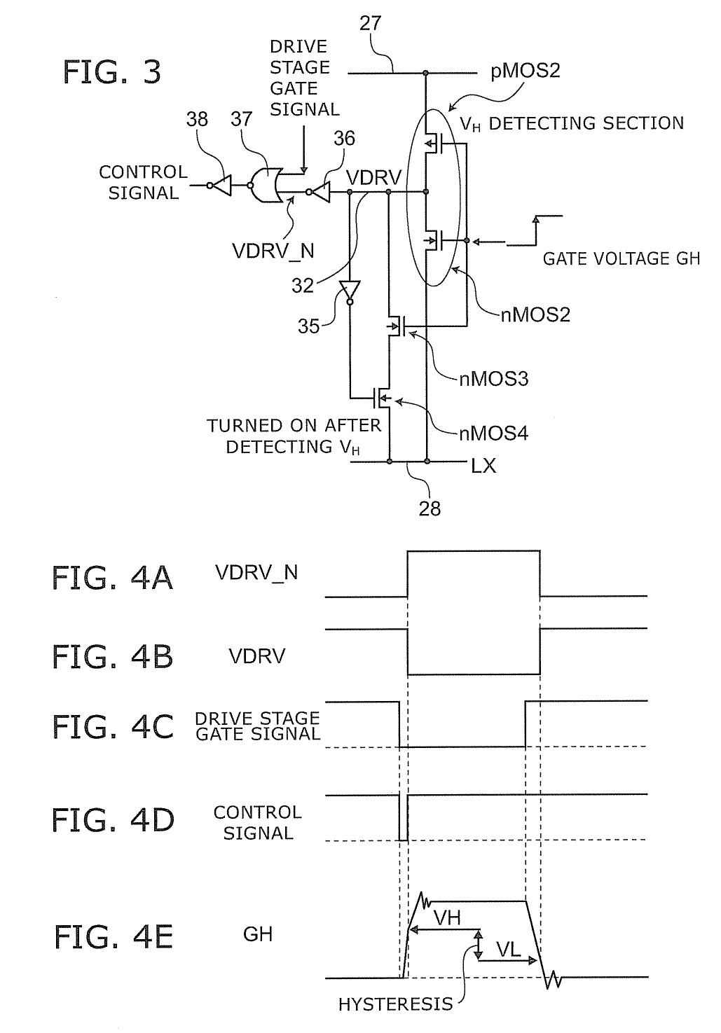

FIG. 3 is a circuit diagram of a first example of the fast drive switch control circuit 18.

pMOS2 and nMOS2 are connected in series between the power supply line 27 and the line 28 described above. The gate voltage GH of the high-side switching element 11 is inputted to the gate of pMOS2 and nMOS2 through a gate voltage detection line 31 shown in FIG. 1. pMOS2 and nMOS2 serve as a detecting section for detecting the on-detection threshold VH of the gate voltage GH of the high-side switching element 11.

Each drain of pMOS2 and nMOS2 is connected to the input terminal of an inverter 36. nMOS3 and nMOS4 are connected in series between the line 28 and the line 32 connecting the drain of pMOS2 and nMOS2 to the inverter 36. The gate voltage GH of the high-side switching element 11 is inputted to the gate of nMOS3. The gate of nMOS4 is connected to the aforementioned line 32 through an inverter 35.

A NOR circuit 37 is provided at the subsequent stage of the inverter 36. An output of the inverter 36 and a drive stage gate signal are inputted to the NOR circuit 37. An output terminal of the NOR circuit 37 is connected to an input terminal of an inverter 38. An output signal of the inverter 38 is supplied to the gate of the fast drive switch 16 as a fast drive switch control signal.

Next, the operation of the fast drive switch control circuit shown in FIG. 3 is described with reference to a waveform timing chart of FIG. 4.

FIG. 4A shows an output signal VDRV_N of the inverter 36 to be inputted to the NOR circuit 37, FIG. 4B shows an input signal VDRV to the inverter 36, FIG. 4C shows a drive stage gate signal applied to the gate of pMOS1 and nMOS1 of the high-side drive circuit 15 and inputted to the NOR circuit 37, FIG. 4D shows an output signal of the inverter 38 (a fast drive switch control signal applied from the fast drive switch control circuit 18 to the gate of the fast drive switch 16), and FIG. 4E shows a gate voltage GH of the high-side switching element 11.

When the gate voltage GH of the high-side switching element 11 is LOW, pMOS2 is turned on, and nMOS2 and nMOS3 are turned off, in the circuit of FIG. 3, then the signal VDRV is HIGH, and hence the signal VDRV_N is LOW. The signal VDRV_N is one input signal to the NOR circuit 37. When the drive stage gate signal switches from HIGH to LOW with the signal VDRV_N is LOW, the both two inputs to the NOR circuit 37 are turned to LOW, and the NOR circuit 37 outputs HIGH to the inverter 38. Hence, the output signal (control signal) of the inverter 38 switches from HIGH to LOW as shown in FIG. 4D. Thus, both pMOS1 and the fast drive switch 16 are turned on as described above with reference to FIG. 1. And positive charge is injected from the power supply line 27 to the gate of the high-side switching element 11 through pMOS1 and the fast drive switch 16, so that the gate voltage GH of the high-side switching element 11 rapidly rises.

After the gate voltage GH rises, when the gate voltage GH reaches or exceeds the on-detection threshold VH, then pMOS2 is turned off, all of nMOS2, nMOS3 and nMOS4 are turned on, in the circuit of FIG. 3. And the signal VDRV switches from HIGH to LOW. Thus, the signal VDRV_N switches from LOW to HIGH, the two inputs to the NOR circuit 37 are then LOW and HIGH, and the NOR circuit 37 outputs LOW to the inverter 38. Hence, the output signal (control signal) of the inverter 38 switches from LOW to HIGH, as shown in FIG. 4D. Therefore, the fast drive switch 16 turns off, and positive charge is injected to the gate of the high-side switching element 11 through only pMOS1.

When the drive stage gate signal switches from LOW to HIGH, then pMOS1 is turned off, nMOS1 is turned on, in the high-side drive circuit 15 of FIG. 1. The gate voltage GH of the high-side switching element 11 starts to fall, because positive charge is extracted from the gate of the high-side switching element 11 through nMOS1.

Then, when the gate voltage GH reaches an off-detection threshold VL, then all of nMOS2, nMOS3 and nMOS4 are turned off, pMOS2 is turned on, in the circuit of FIG. 3. And the signal VDRV switches from LOW to HIGH. Thus, the signal VDRV_N switches from HIGH to LOW. The two inputs to the NOR circuit 37 are then LOW and HIGH, and the NOR circuit 37 outputs LOW to the inverter 38. Hence, the output signal (control signal) of the inverter 38 remains HIGH, and the fast drive switch 16 remains turned off.

The size ratio among nMOS2, nMOS3, and nMOS4 in the circuit of FIG. 3 is adjusted to provide hysteresis to the circuit, thereby configuring the on-detection threshold VH and the off-detection threshold VL of the gate voltage GH.

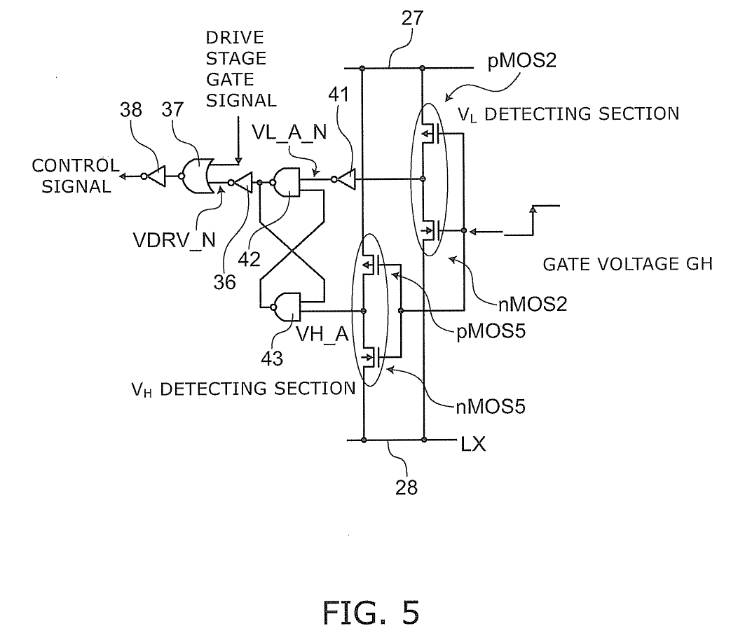

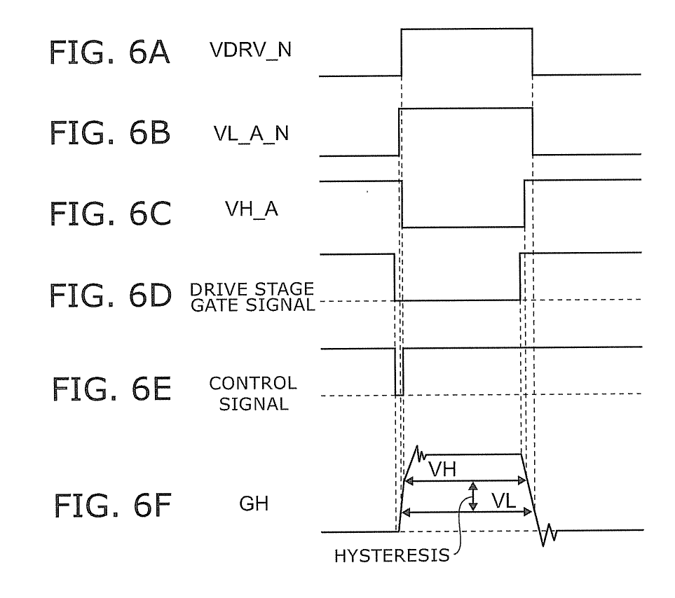

FIG. 5 is a circuit diagram of a second example of the fast drive switch control circuit 18.

pMOS2 and nMOS2 are connected in series between the power supply line 27 and the line 28. The gate voltage GH of the high-side switching element 11 is inputted to the gate of pMOS2 and nMOS2. pMOS2 and nMOS2 serve as a detecting section for detecting the off-detection threshold VL of the gate voltage GH of the high-side switching element 11.

pMOS5 and nMOS5 are connected in series between the power supply line 27 and the line 28. The gate voltage GH of the high-side switching element 11 is inputted to the gate of pMOS5 and nMOS5. pMOS5 and nMOS5 serve as a detecting section for detecting the on-detection threshold VH of the gate voltage GH of the high-side switching element 11.

The size ratio between pMOS5 and nMOS5 in the VH detecting section and the size ratio between pMOS2 and nMOS2 in the VL detecting section in the circuit of FIG. 5 are adjusted to provide hysteresis to the circuit, thereby configuring the on-detection threshold VH and the off-detection threshold VL of the gate voltage GH.

The drain of pMOS2 and nMOS2 is connected to the input terminal of an inverter 41. An output terminal of the inverter 41 is connected to one input terminal of a NAND circuit 42. The drain of pMOS5 and nMOS5 is connected to one input terminal of a NAND circuit 43. The other input terminal of the NAND circuit 43 is connected to the output terminal of the NAND circuit 42. The output terminal of the NAND circuit 43 is connected to the other input terminal of the NAND circuit 42. The output terminal of the NAND circuit 42 is connected to the input terminal of an inverter 36.

A NOR circuit 37 is provided at the subsequent stage of the inverter 36. The output of the inverter 36 and the drive stage gate signal are inputted to the NOR circuit 37. The output terminal of the NOR circuit 37 is connected to the input terminal of an inverter 38. The output signal of the inverter 38 is supplied to the gate of the fast drive switch 16 as a fast drive switch control signal.

Next, an operation of the fast drive switch control circuit shown in FIG. 5 is described with reference to a waveform timing chart of FIG. 6.

FIG. 6A shows an output signal VDRV_N of the inverter 36 to be inputted to the NOR circuit 37, FIG. 6B shows an output signal VL_A_N of the inverter 41, FIG. 6C shows an output signal VH_A of the VH detecting section, FIG. 6D shows a drive stage gate signal, FIG. 6E shows an output signal of the inverter 38 (a fast drive switch control signal applied from the fast drive switch control circuit 18 to the gate of the fast drive switch 16), and FIG. 6F shows a gate voltage GH of the high-side switching element 11.

The signal VDRV_N is LOW when the gate voltage GH of the high-side switching element 11 is LOW, pMOS2 and pMOS5 are turned on, and nMOS2 and nMOS5 are turned off, in the circuit of FIG. 5. When the drive stage gate signal switches from HIGH to LOW while the signal VDRV_N being one input signal to the NOR circuit 37 is LOW, then the both two inputs to the NOR circuit 37 are both turned to LOW, and the NOR circuit 37 outputs HIGH to the inverter 38. Hence, the output signal (control signal) of the inverter 38 switches from HIGH to LOW as shown in FIG. 6E. Thus, as described above with reference to FIG. 1, both pMOS1 and the fast drive switch 16 are turned on, and positive charge is injected from the power supply line 27 through pMOS1 and the fast drive switch 16 to the gate of the high-side switching element 11. Therefore, the gate voltage GH of the high-side switching element 11 rapidly rises.

After the rise in the gate voltage GH, when the gate voltage GH exceeds the off-detection threshold VL, then pMOS2 is turned off, nMOS2 is turned on, in the VL detecting section, and VL_A_N switches from LOW to HIGH. Furthermore, when the gate voltage GH exceeds the on-detection threshold VH, then pMOS5 is turned off, nMOS5 is turned on, in the VH detecting section, and VH_A switches from HIGH to LOW.

Thus, VDRV_N switches from LOW to HIGH, the two inputs to the NOR circuit 37 are then LOW and HIGH, and the NOR circuit 37 outputs LOW to the inverter 38. Hence, the output signal (control signal) of the inverter 38 switches from LOW to HIGH as shown in FIG. 6E. Therefore, the fast drive switch 16 turns off, and positive charge is injected to the gate of the high-side switching element 11 through only pMOS1 shown in FIG. 1.

When the drive stage gate signal switches from LOW to HIGH, then pMOS1 is turned off and nMOS1 is turned on, in the high-side drive circuit 15 of FIG. 1, positive charge is extracted from the gate of the high-side switching element 11 through nMOS1, and the gate voltage GH of the high-side switching element 11 starts to fall.

Then, when the gate voltage GH falls below the on-detection threshold VH, then pMOS5 is turned on, nMOS5 is turned off, in the VH detecting section, and VH_A switches from LOW to HIGH. Furthermore, when the gate voltage GH falls below the off-detection threshold VL, then pMOS2 is turned on, nMOS2 is turned off, in the VL detecting section, and VL_A_N switches from HIGH to LOW.

Thus, the signal VDRV_N switches from HIGH to LOW. The two inputs to the NOR circuit 37 are then LOW and HIGH, and the NOR circuit 37 outputs LOW to the inverter 38. Hence, the output signal (control signal) of the inverter 38 remains HIGH, and the fast drive switch 16 remains turned off.

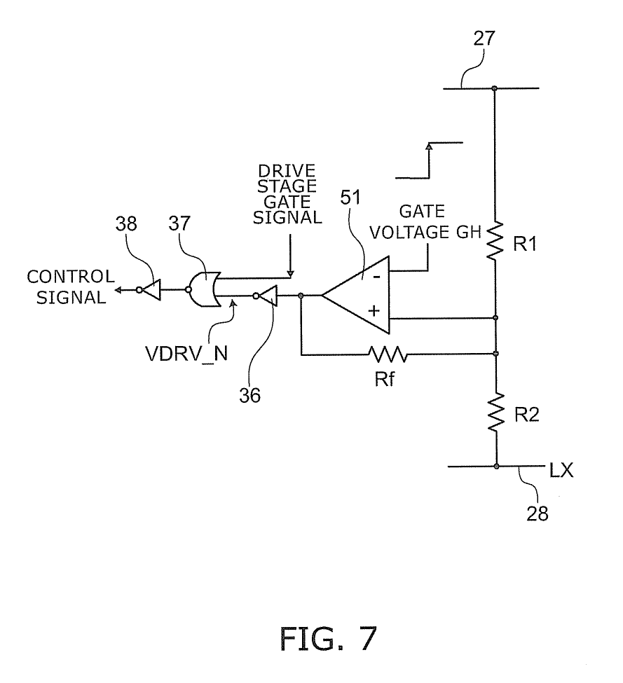

FIG. 7 is a circuit diagram of a third example of the fast drive switch control circuit 18.

A resistor R1 and a resistor R2 are connected in series between the power supply line 27 and the line 28. The connection line between the resistor R1 and the resistor R2 is connected to the non-inverting input terminal of a differential amplifier 51. The gate voltage GH of the high-side switching element 11 is inputted to the inverting input terminal of the differential amplifier 51. The output terminal of the differential amplifier 51 is connected to the input terminal of an inverter 36. Furthermore, the output terminal of the differential amplifier 51 is connected to the connection line between the resistor R1 and the resistor R2 through a resistor Rf.

A NOR circuit 37 is provided at the subsequent stage of the inverter 36. The output of the inverter 36 and the drive stage gate signal are inputted to the NOR circuit 37. The output terminal of the NOR circuit 37 is connected to the input terminal of an inverter 38. The output signal of the inverter 38 is supplied to the gate of the fast drive switch 16 as a fast drive switch control signal.

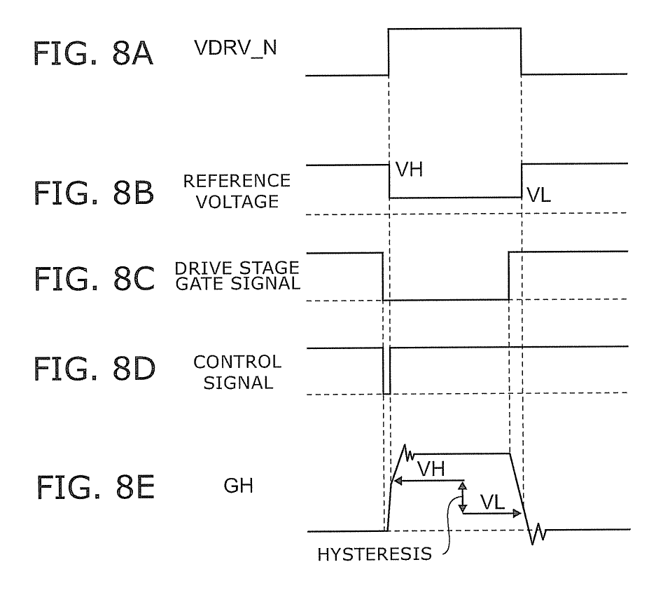

Next, an operation of the fast drive switch control circuit shown in FIG. 7 is described with reference to a waveform timing chart of FIGS. 8A to 8E.

FIG. 8A shows an output signal VDRV_N of the inverter 36 to be inputted to the NOR circuit 37, FIG. 8B shows a reference voltage inputted to the non-inverting input terminal of the differential amplifier 51, FIG. 8C shows a drive stage gate signal, FIG. 8D shows an output signal of the inverter 38 (a fast drive switch control signal applied from the fast drive switch control circuit 18 to the gate of the fast drive switch 16), and FIG. 8E shows a gate voltage GH of the high-side switching element 11.

Here, an on-detection threshold VH is the HIGH level in the reference voltage. The on-detection threshold VH is a voltage obtained by dividing the power supply voltage applied to the power supply line 27 by the resistor R1 and the resistor R2. An off-detection threshold VL is the LOW level in the reference voltage. The off-detection threshold VL is a voltage obtained by dividing the power supply voltage applied to the power supply line 27 by the resistor R1 and (resistor Rf/resistor R2).

When the gate voltage GH of the high-side switching element 11 is LOW, the reference voltage is HIGH, the output of the differential amplifier 51 is HIGH, and the signal VDRV_N is LOW. When the drive stage gate signal switches from HIGH to LOW while the signal VDRV_N being one input signal to the NOR circuit 37 is LOW, then both the two inputs to the NOR circuit 37 are turned to LOW, and the NOR circuit 37 outputs HIGH to the inverter 38. Hence, the output signal (control signal) of the inverter 38 switches from HIGH to LOW as shown in FIG. 8D. Thus, as described above with reference to FIG. 1, both pMOS1 and the fast drive switch 16 are turned on. And positive charge is injected from the power supply line 27 to the gate of the high-side switching element 11 through pMOS1 and the fast drive switch 16 to the gate of the high-side switching element 11, so that the gate voltage GH of the high-side switching element 11 rapidly rises.

After the rise in the gate voltage GH, when the gate voltage GH exceeds the on-detection threshold VH, the reference voltage switches from HIGH to LOW, and the output of the differential amplifier 51 switches from HIGH to LOW. Thus, VDRV_N switches from LOW to HIGH, the two inputs to the NOR circuit 37 are then LOW and HIGH, and the NOR circuit 37 outputs LOW to the inverter 38. Hence, the output signal (control signal) of the inverter 38 switches from LOW to HIGH as shown in FIG. 8D. Therefore, the fast drive switch 16 turns off, and positive charge is injected to the gate of the high-side switching element 11 through only pMOS1 shown in FIG. 1.

When the drive stage gate signal switches from LOW to HIGH, then pMOS1 is turned off and nMOS1 is turned on, in the high-side drive circuit 15 of FIG. 1, positive charge is extracted from the gate of the high-side switching element 11 through nMOS1, and the gate voltage GH of the high-side switching element 11 starts to fall.

Then, when the gate voltage GH falls below the off-detection threshold VL, the reference voltage switches from LOW to HIGH, and the output of the differential amplifier 51 switches from LOW to HIGH. Thus, the signal VDRV_N switches from HIGH to LOW. The two inputs to the NOR circuit 37 are then LOW and HIGH, and the NOR circuit 37 outputs LOW to the inverter 38. Hence, the output signal (control signal) of the inverter 38 remains HIGH, and the fast drive switch 16 remains turned off.

### Second Embodiment

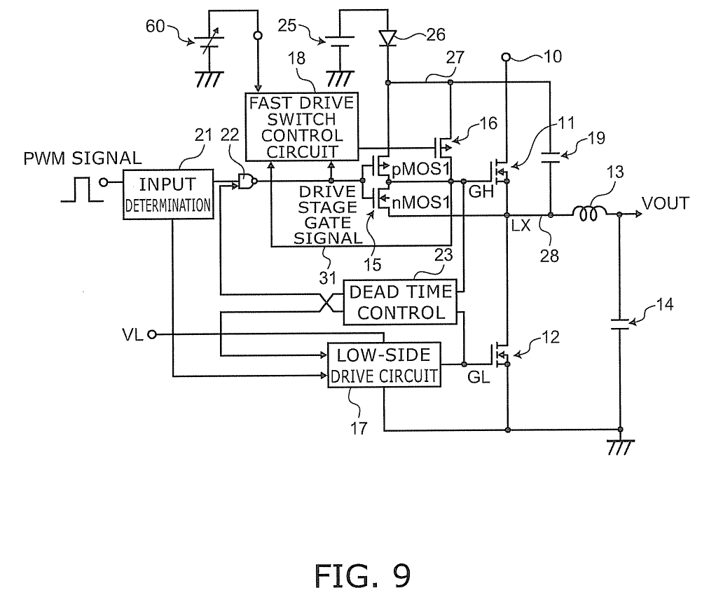

FIG. 9 is a circuit diagram of a DC-DC converter according to a second embodiment of the invention. Substantially the same elements as in the above embodiment are labeled with like reference numerals, and the description thereof may be omitted.

A variable voltage source 60 is used so that the aforementioned on-detection threshold of the gate voltage GH configured in the fast drive switch control circuit 18 can be externally adjusted in this embodiment. Switching loss and noise level can be taken into consideration to configure the on-detection threshold with high accuracy by adjusting the on-detection threshold in accordance with the size and characteristics of the high-side switching element 11.

### Third Embodiment

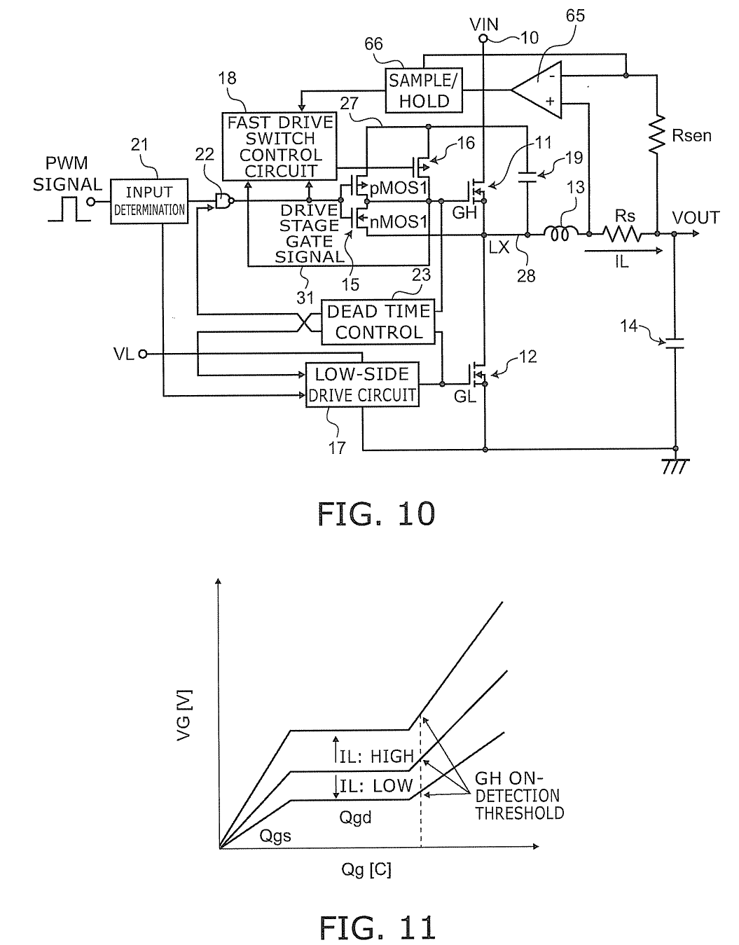

FIG. 10 is a circuit diagram of a DC-DC converter according to a third embodiment of the invention. Substantially the same elements as in the above embodiment are labeled with like reference numerals, and the description thereof may be omitted.

A circuit having a sense resistor Rs is added to the above first embodiment in this embodiment. An output current IL flowing through the inductor 13 is sensed by the sense resistor Rs to adjust the on-detection threshold of the gate voltage GH of the high-side switching element 11.

The sense resistor Rs is connected in series with the inductor 13. One end of the sense resistor Rs connected to the inductor 13 is connected to a non-inverting input terminal of a differential amplifier 65, and the other end of the sense resistor Rs is connected to an inverting input terminal of the differential amplifier 65 through a resistor Rsen. An output of the differential amplifier 65 is sample-held by a sample/hold circuit 66 and supplied to the fast drive switch control circuit 18. The output current IL is sensed as the voltage across the sense resistor Rs. The on-detection threshold of the gate voltage GH is adjusted on the basis of the sensed output current IL. Insertion of the sense resistor Rs in series with the inductor 13 allows the output current IL to be accurately sensed.

As shown in FIG. 11, the on-detection threshold increases as the output current IL increases, and the on-detection threshold decreases as the output current IL decreases. In FIG. 11, the vertical axis represents gate voltage VG, and the horizontal axis represents charge Qg accumulated in the gate.

Hence, the on-detection threshold is configured at a high level when the sensed output current IL increases in the circuit of this embodiment. Conversely, the on-detection threshold is configured at a low level when the output current IL decreases.

Specifically, the on-detection threshold is configured in accordance with the sensed output current IL by varying the size ratio of MOSFET in the fast drive switch control circuit shown in FIGS. 3 and 5. The on-detection threshold is configured in accordance with the sensed output current IL by varying the resistance of the resistors R1, R2, and/or Rf in the fast drive switch control circuit shown in FIG. 7. Therefore, efficiency can be further improved.

### Fourth Embodiment

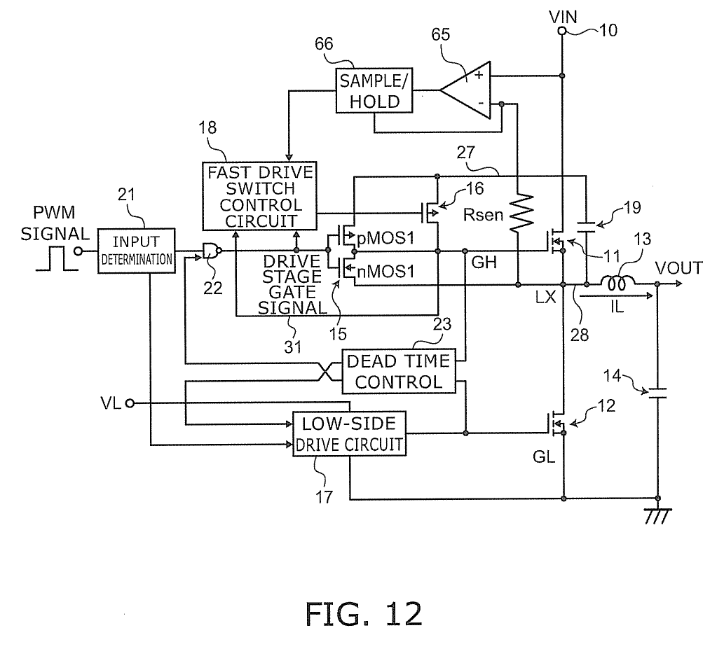

FIG. 12 is a circuit diagram of a DC-DC converter according to a fourth embodiment of the invention. Substantially the same elements as in the above embodiment are labeled with like reference numerals, and the description thereof may be omitted.

This embodiment includes a circuit to adjust the on-detection threshold in accordance with the sensed output current IL like the above third embodiment. The output current IL flowing through the inductor 13 is sensed as the voltage across the on-resistance RDS(ON) of the high-side switching element 11 in the circuit. The circuit of this embodiment can control the on-detection threshold by directly using signals with reference to the output voltage LX. The circuit configuration is simplified in this embodiment.

### Fifth Embodiment

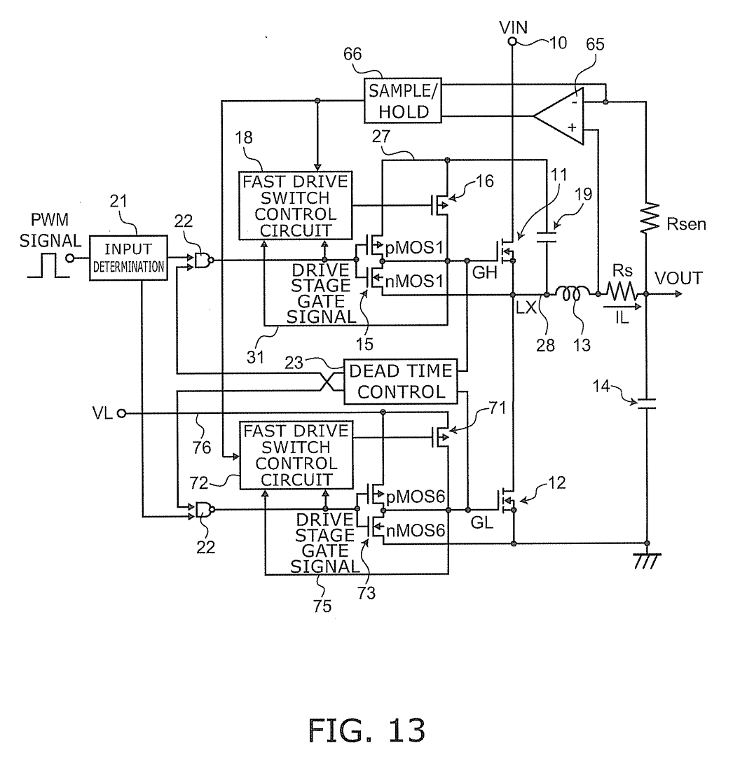

FIG. 13 is a circuit diagram of a DC-DC converter according to a fifth embodiment of the invention. Substantially the same elements as in the above embodiment are labeled with like reference numerals, and the description thereof may be omitted.

A fast drive switch 71 and a fast drive switch control circuit 72 for controlling the fast drive switch 71 are provided also on the low side in this embodiment.

The low-side drive circuit 73 includes pMOS6 and nMOS6. A drain of the pMOS6 and a drain of the nMOS6 are connected to the gate of the low-side switching element 12. The low-side drive circuit 73 drives the gate of the low-side switching element 12. The pMOS6 and the fast drive switch 71 are connected in parallel between the gate of the low-side switching element 12 and a power supply line 76 for applying a power supply voltage VL to the low-side drive circuit 73. The fast drive switch control circuit 72 monitors the gate voltage GL of the low-side switching element 12 through a line 75.

The low-side fast drive switch 71 is operated similarly to the high-side fast drive switch 16 described above with reference to FIG. 2. More specifically, both the pMOS6 and the fast drive switch 71 are turned on to increase the current capacity of the gate drive circuit to achieve steep rise at the rise time of the gate voltage GL of the low-side switching element 12 also on the low side. The fast drive switch 71 is turned off as upon completion of the rise of the output voltage LX. Therefore, the current capacity of the gate drive circuit is decreased to suppress noise. When the gate voltage GL exceeds a GL on-detection threshold (second threshold) configured in the fast drive switch control circuit 72, the fast drive switch control signal switches from LOW to HIGH to turn off the fast drive switch 71. Therefore, charge is injected to the gate of the low-side switching element 12 through only pMOS6 of the low-side drive circuit 73.

Noise in the output voltage LX depends on the rising signal of the gate voltage GH of the high-side switching element 11 and the rising signal of the gate voltage GL of the low-side switching element 12. Hence, the noise in the output voltage LX can be further suppressed by adding the fast drive switches 16 and 71 to each of the high side and the low side for control as described above.

### Sixth Embodiment

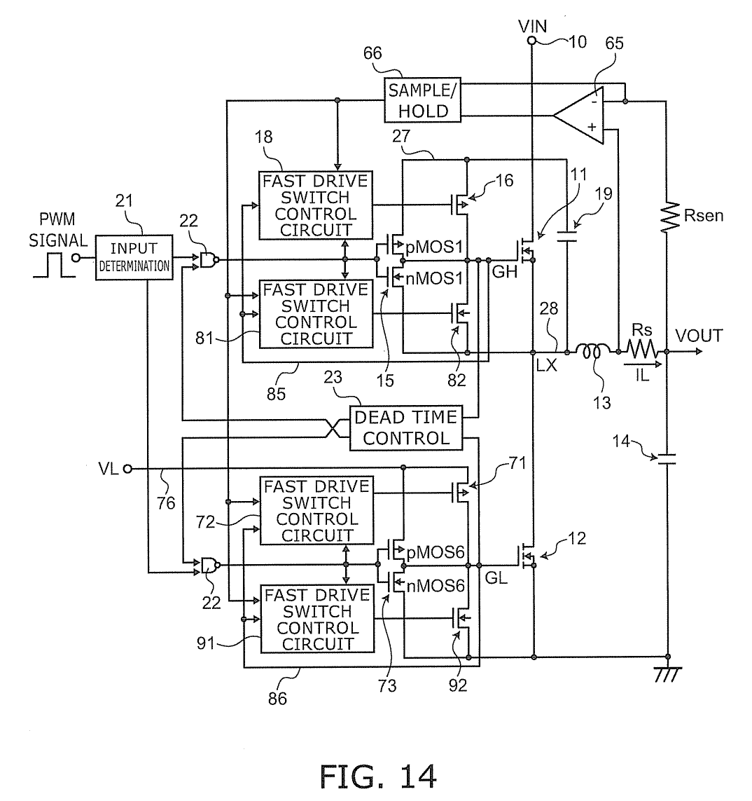

FIG. 14 is a circuit diagram of a DC-DC converter according to a sixth embodiment of the invention. Substantially the same elements as in the above embodiment are labeled with like reference numerals, and the description thereof may be omitted.

The nMOS1 of the high-side drive circuit 15 and a fast drive switch 82 are connected in parallel between the gate of the high-side switching element 11 and the line 28. Furthermore, a fast drive switch control circuit 81 for controlling the fast drive switch 82 is provided. The fast drive switch control circuit 81 monitors the gate voltage GH of the high-side switching element 11 through a line 85.

The nMOS6 of the low-side drive circuit 73 and a fast drive switch 92 are connected in parallel between the gate of the low-side switching element 12 and the ground. Furthermore, a fast drive switch control circuit 91 for controlling the fast drive switch 92 is provided. The fast drive switch control circuit 91 monitors the gate voltage GL of the low-side switching element 12 through a line 86.

The fast drive switches 82 and 92 added in this embodiment are controlled similarly to the fast drive switches 16 and 71 described above. Both the nMOS1 and the fast drive switch 82 are turned on to increase the current capacity (charge extraction capacity) of the gate drive circuit to achieve steep fall at the fall time of the gate voltage GH of the high-side switching element 11. The fast drive switch 82 is turned off as upon completion of the fall of the output voltage LX. Therefore, the charge extraction capacity of the gate drive circuit is decreased to suppress noise.

Likewise, both the nMOS6 and the fast drive switch 92 are turned on to increase the current capacity (charge extraction capacity) of the gate drive circuit to achieve steep fall at the fall time of the gate voltage GL of the low-side switching element 12. The fast drive switch 92 is turned off as upon completion of the fall of the output voltage LX. Therefore, the charge extraction capacity of the gate drive circuit is decreased to suppress noise.

Thus, the rise and fall time can be decreased and switching loss can be reduced in both the high-side switching element 11 and the low-side switching element 12.

The fifth or sixth embodiment includes the on-detection threshold adjustment circuit based on output current detection illustrated in the third embodiment. However, it may be replaced by the on-detection threshold adjustment circuit of the fourth embodiment.

The above DC-DC converters are based on a three-chip configuration. The three-chip is composed of a semiconductor chip constituting the high-side switching element, a semiconductor chip constituting the low-side switching element, and a semiconductor chip including a control circuit (including the drive circuit, the fast drive switch, the fast drive switch control circuit, and the like) for controlling these switching elements. However, the invention is not limited thereto. The high-side switching element, the low-side switching element, and the control circuit may be integrated into one chip. One of the high-side switching element and the low-side switching element may be integrated with the control circuit into one chip.

The invention is not limited to stepdown converters, but also applicable to stepup converters.

1. A converter control circuit comprising:
a high-side switching element connected between an input voltage terminal and an inductive load;
a low-side switching element connected between the inductive load and a reference potential;
a drive circuit configured to drive a gate of the switching elements;
a drive switch connected to the gate of at least one of the switching elements in parallel with the drive circuit; and
a drive switch control circuit switching the drive switch from ON to OFF when the gate voltage of the switching element with the gate connected to the drive switch reaches a prescribed threshold while the switching element is driven by the drive circuit.

2. The converter control circuit according to claim 1, wherein the drive switch is connected to a gate of the high-side switching element in parallel with a high-side drive circuit to drive the gate of the high-side switching element.

3. The converter control circuit according to claim 2, wherein the prescribed threshold is an on-detection threshold at which the high-side switching element is turned on.

4. The converter control circuit according to claim 3, further comprising:
an output current detective circuit sensing an output current of the converter,
the on-detection threshold being configured in accordance with the output current.

5. The converter control circuit according to claim 4, wherein the output current detective circuit includes a sense resistor connected in series with the inductive load.

6. The converter control circuit according to claim 4, wherein the output current detective circuit senses the output current as voltage across on-resistance of the high-side switching element.

7. The converter control circuit according to claim 4, wherein the on-detection threshold increases as the output current is relatively high, and the on-detection threshold decreases as the output current is relatively low.

8. The converter control circuit according to claim 3, wherein the on-detection threshold is configured by an external signal supplied to the drive switch control circuit.

9. The converter control circuit according to claim 1, wherein the drive switch is connected to a gate of the low-side switching element in parallel with the low-side drive circuit to drive the gate of the low-side switching element.

10. The converter control circuit according to claim 9, wherein the prescribed threshold is an on-detection threshold at which the low-side switching element is turned on.

11. The converter control circuit according to claim 10, further comprising:
an output current detective circuit sensing an output current of the converter,
the on-detection threshold being configured in accordance with the output current.

12. The converter control circuit according to claim 11, wherein the output current detective circuit includes a sense resistor connected in series with the inductive load.

13. The converter control circuit according to claim 11, wherein the output current detective circuit senses the output current as voltage across on-resistance of the low-side switching element.

14. The converter control circuit according to claim 11, wherein the on-detection threshold increases as the output current is relatively high, and the on-detection threshold decreases as the output current is relatively low.

15. The converter control circuit according to claim 10, wherein the on-detection threshold is externally configured for the drive switch control circuit configured to switch the low-side drive switch.

16. The converter control circuit according to claim 1, wherein
the drive circuit comprises a high-side drive circuit to drive the gate of the high-side switching element, and a low-side drive circuit to drive the gate of the low-side switching element,
the drive switch comprises a high-side drive switch connected to the gate of the high-side switching element in parallel with the high-side drive circuit, and a low-side drive switch connected to the gate of the low-side switching element in parallel with the low-side drive circuit, and
the drive switch control circuit comprises a high-side drive switch control circuit to switch the high-side drive switch from ON to OFF when a gate voltage of the high-side switching element reaches a first threshold while the high-side switching element is driven, and a low-side drive switch control circuit to switch the low-side drive switch from ON to OFF when a gate voltage of the low-side switching element reaches a second threshold while the low-side switching element is driven.

17. The converter control circuit according to claim 16, wherein the high-side switching element is turned on at the first threshold, and the low-side switching element is turned on at the second threshold.

18. The converter control circuit according to claim 17, further comprising:
an output current detective circuit sensing an output current of the converter,
the on-detection threshold being configured in accordance with the output current.

19. The converter control circuit according to claim 18, wherein the on-detection threshold is increased when the output current is relatively high, and the on-detection threshold is decreased when the output current is relatively low.

20. The converter control circuit according to claim 17, wherein the on-detection threshold is configured by an external signal supplied to the drive switch control circuit.
